(19) United States
(12) Patent Application Publication
(10) Pub. No.: US 2004/0260641 A1
(43) Pub. Date: Dec. 23, 2004

(54) Internet auction game

(76) Inventor: Einat Cohen, Ramat HaSharon (IL)

Correspondence Address: Martin MOYNIHAN, c/o ANTHONY CASTORINA, SUITE 207, 2001 JEFFERSON DAVIS HIGHWAY, ARLINGTON, VA, 22202, US

(21) Appl. No.: 10/860,144

(22) Filed: Jun. 4, 2004

Related U.S. Application Data
(60) Provisional application No. 60/475,772, filed on Jun. 5, 2003.

(51) Int. Cl. G06F 17/60

(52) U.S. Cl. 705/37

(57) ABSTRACT

A method for an online auction game for a product for a plurality of users, comprising: providing a display for displaying the game to each user; placing a bid in a bidding process by a user; altering the display to show progress in the bidding process to each user; and constraining the bidding process to a predetermined period of time, such that the bid is alterable during the predetermined period of time.

### RELATIONSHIP TO EXISTING APPLICATIONS

The present application claims priority from U.S. Provisional Patent Application No. 60/475,772 filed Jun. 5, 2003.

### FIELD AND BACKGROUND OF THE INVENTION

The present invention relates to the field of software interactions over a network and more particularly but not exclusively to the field of multi-participant games.

### SUMMARY OF THE INVENTION

According to a first aspect of the present invention there is provided a method for an online auction game for a product for a plurality of users, comprising:

providing a display for displaying the game to each user;

placing a bid in a bidding process by a user;

altering said display to show progress in said bidding process to each user; and

constraining the bidding process to a predetermined period of time, such that said bid by said user is alterable during said predetermined period of time.

Preferably, the display shows a plurality of markers, and wherein said placing said bid comprises purchasing a marker by said user.

Preferably, the bidding process comprises:

displaying bids by the plurality of users; and

moving a selection marker on said display to a marker for a bid according to a plurality of criteria, said criteria including price of said bid;

wherein said user is capable of placing a plurality of bids and wherein a winner of the auction game is determined according to a location of said selection marker.

The game of the present invention (the bid) combines a number of skills which makes it more interesting and exciting. It may include participation by one player or a team.

It demands thought, skill, the ability to concentrate and staying power at demands, the ability to memorize, quick decision making and quick mathematical calculations.

### DESCRIPTION OF THE PREFERRED EMBODIMENTS

Hardware/Software Demands

For this example, the participant needs a computer with a connection to the internet as well as a Web browser such as internet explorer and a flash player. However, the game may also be played through a cellular telephone or a wireless PDA for example.

The software has a Client/Server Architecture. The server side application will manage all the players (Clients) and the timer indicating the end of the game. The client application is the front end for the user and enables him to participate in the game and take active steps. At the end of the game the server takes control and declare the winner according to the rules of the game.

The Auction

The auction is comprised of two stages- an active stage and a passive stage. The passive stage is the stage where players sign on and pay for their bids. Only players who sign on and pay for their bids can participate in the next stage, online. The players may see a picture of the goods being auctioned, such as an automobile for example. During this early stage, each player may receive two blocks for the price of one. For this example, one will be registered immediately and the second, when the game goes online. A player can buy as many blocks as he wishes.

During the auction, the player will see his chosen blocks in one color and all the other players' blocks in another color. The blocks that haven't been bought will appear in a third shade while the electronic cursor will appear in a forth shade. The player will see the blocks taken only when the auction starts and during the auction. If a player wants to buy a taken block the system will announce the player that the block is taken and will offer him another block.

The Electronic Cursor

The electronic cursor operates from the beginning of the game and the amount of time that the cursor takes to move from block to block will be decided beforehand by the Auction Committee. The time factor will be displayed on the board. The movement of the cursor is important because as described below, it determines the winner of the game.

The cursor starts at the lowest numbered block and then begins to move independently during the game, but preferably always toward the higher numbered blocks. The electronic cursor cannot move past a block that has not been bought so if this happens, it will stop. When it starts up again after a long stop, it will move more slowly that before. The company will decide what length of stop will cause the cursor to move more slowly thereafter. This will be programmed automatically.

The winning number will be the one where the cursor stops at the end of the game.

The Online Auction

The length of time the online auction will be played is decided by the committee, depending on the number of participants.

When they go online, each player will see the blocks that have been bought by other participants. The aim of each player, or team of players is to guess where the cursor will settle at the end of the game. To do this, the players should buy up open squares and help the cursor move toward the blocks they have bought.

All players will be trying to get the cursor to stop on the blocks they've bought which should lead to mass buying. As a result the product's price will probably rise, assuming that each number on the block represents a purchase price for the product. The maximum amount a player may be required to pay is 10% of the price of the product being auctioned. For this example, if the cursor stops on a block owned by a player, then in order to obtain the product being auctioned, the player must then pay an amount of currency according to the number on the block; for example, if the number on the block is 10, then the player would pay $10 to obtain the product.

If a player is online and he's marked all the blocks he bought during the online stage he can purchase more at a price set by the committee.

At the end of the auction, the winner will be announced. If he can't pay the price, the player with the block nearest to him is the winner.

Auction Rules

1. The auction will be conducted in two stages. During the first stage, the public will be invited to bid for the product of their choice.

a. They can bid via the Internet.

b. They can bid via a telephone call center.

c. The cost of each bid will be decided in advance by the Auction Company.

2. In order to bid, a player needs to give his credit card number as well as any personal details required. After authorization by the credit card company, his bid will be accepted by the Auction Company.

3. The Auction Company has to decide on a minimum amount of participants for each item to be auctioned. If they don't get the minimum amount of participants, they reserve the right to postpone the auction and will post the new date and time on the Internet. The information can also be obtained from the telephone call center.

4. The first person to choose a price from the numbered squares shown on the screen, will obtain that number on a ‘first come, first served’ basis. No two people will be allowed to choose the same number as each number represents a price. If this happens, the second player will have to choose another price square.

5. At the end of the first part of the game, there will be an online auction. Players who bought price squares during stage one, have the opportunity of buying the same amount of squares online, free of charge.

6. Only players who have filled in their personal details, paid by credit card and chosen their price squares before the online auction has begun, can participate.

7. The Auction Company doesn't accept bids online from a player who has not placed his bid in the first stage of the game.

8. A player is entitled to make unlimited offers once the auction has begun.

9. Once the auction begins and the participant is online, offers can only be made online and not via a telephone call center.

10. Each participant's bid will be recorded on his computer screen in color. Bids by other players will be displayed in another color. A running account of each player's moves will be recorded on the right hand side of his computer screen.

The Auction Company will record the relevant information of each player's account and reserves their right to hand it over to the supervisory committee, if necessary.

11. Once the auction starts online, the player can make more bids on a ‘first come, first served” basis. These prices will show up in his color on his screen.

12. No two people can choose the same price block. If two players make the same bid, the second has to choose another price square.

Method of Auction.

13. The allotted time for each online auction will be decided beforehand by the Auction Company.

14. When the online auction starts, each player will see a screen that has been divided into number blocks. Each number represents a price.

15. When the online auction begins, all the price blocks that have been bought during stage one, will appear on the screen.

16. The auction will be open for a limited period of time. During that time, a player can make additional offers by pointing the cursor at any available price block and clicking once on the mouse. Each extra click will cost twice as much as the pre-online price.

17. During the online auction, the Company will operate an electronic cursor that will mark the highest bid at every stage of the game. When the time is up, it will mark the winning block (or price). The cursor can't jump over an empty block and will stop if a price Block has not been paid for. The Company will decide on a time Limit for each forward move of the cursor.

Announcing the Winner.

18. At the end of the auction, the winner will be chosen by the electronic cursor. The maximum price a winner will have to pay is 10% of the listed price of the product.

19. At the end of the auction (when the time limit expires) the bid which will be highlighted by the cursur will win. In order to score a win, every single price square, from the minimum price up to the highlighted one, has to have been bought by a bidder.

20. If a credit card is not valid for any reason, the second highest bid will be the winner.

This example of the game is further described with regard to the Figures.

Figure one

The figure shows a display that is shown to the user before the auction begins. The user is shown the object to be obtained through the auction as well as a plurality of squares, a time frame after which the auction will begin and a bid registration form.

Figure Two

The figure shows a display that is shown to the user after he registered and several minutes before the auction starts. The user is shown a plurality of squares that represents the object's price range. The squares that were purchased by the user are marked by color (for example-red). The user is shown his account.

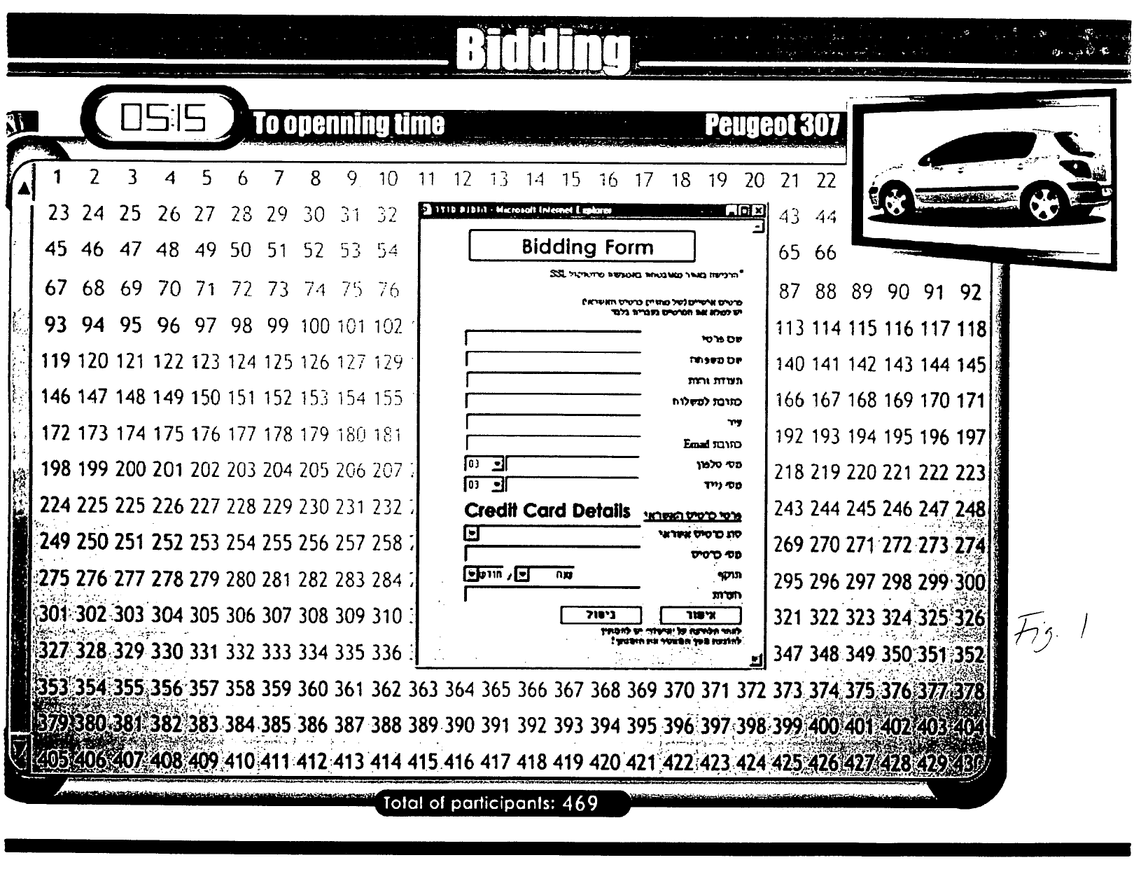

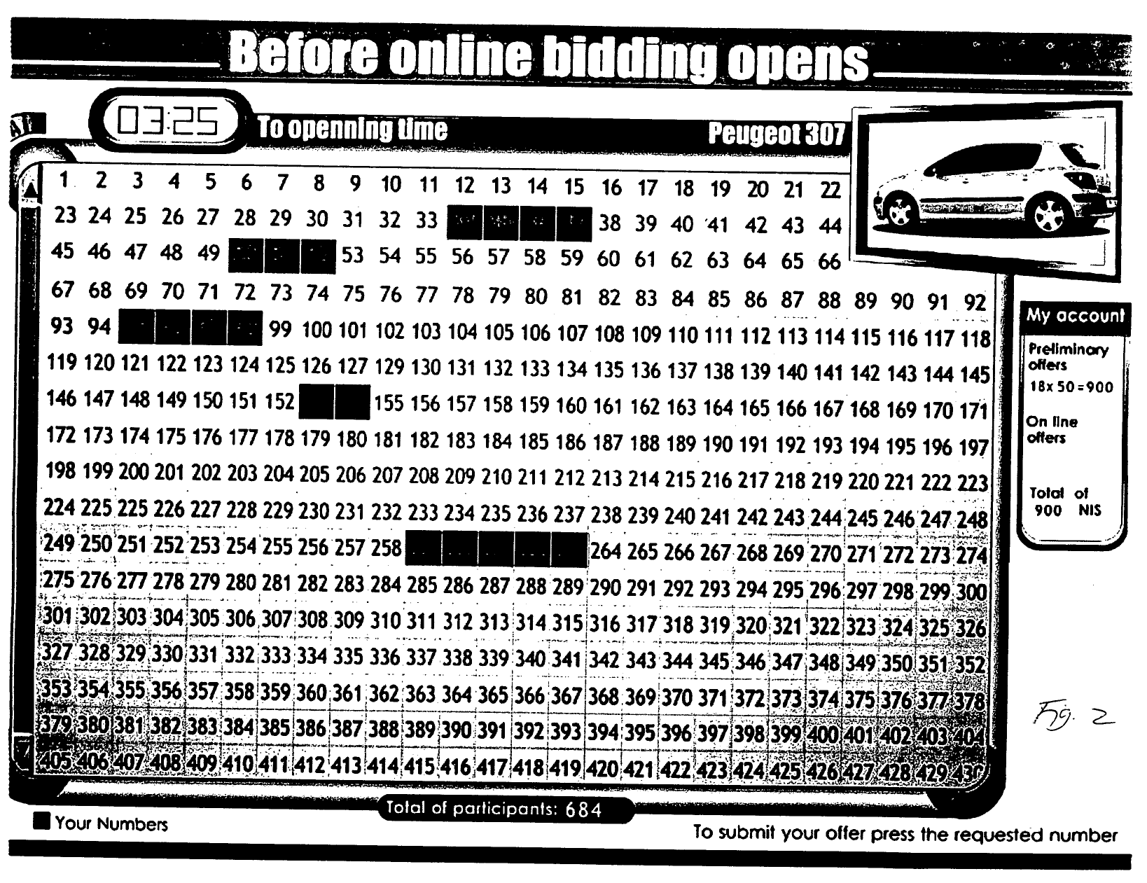

FIG. 3

The auction begins. The user is shown a display of squares ranging from 1 to the maximum price of the object (which is 10% of its original price). The squares that were bought by the user before the auction started are marked with a certain color (for example-red) and the squares bought by other users before the auction started are marked with a different color (for example-gray). The user is shown the time limit in which the auction will take place (for example-The auction will end in 5 minutes).

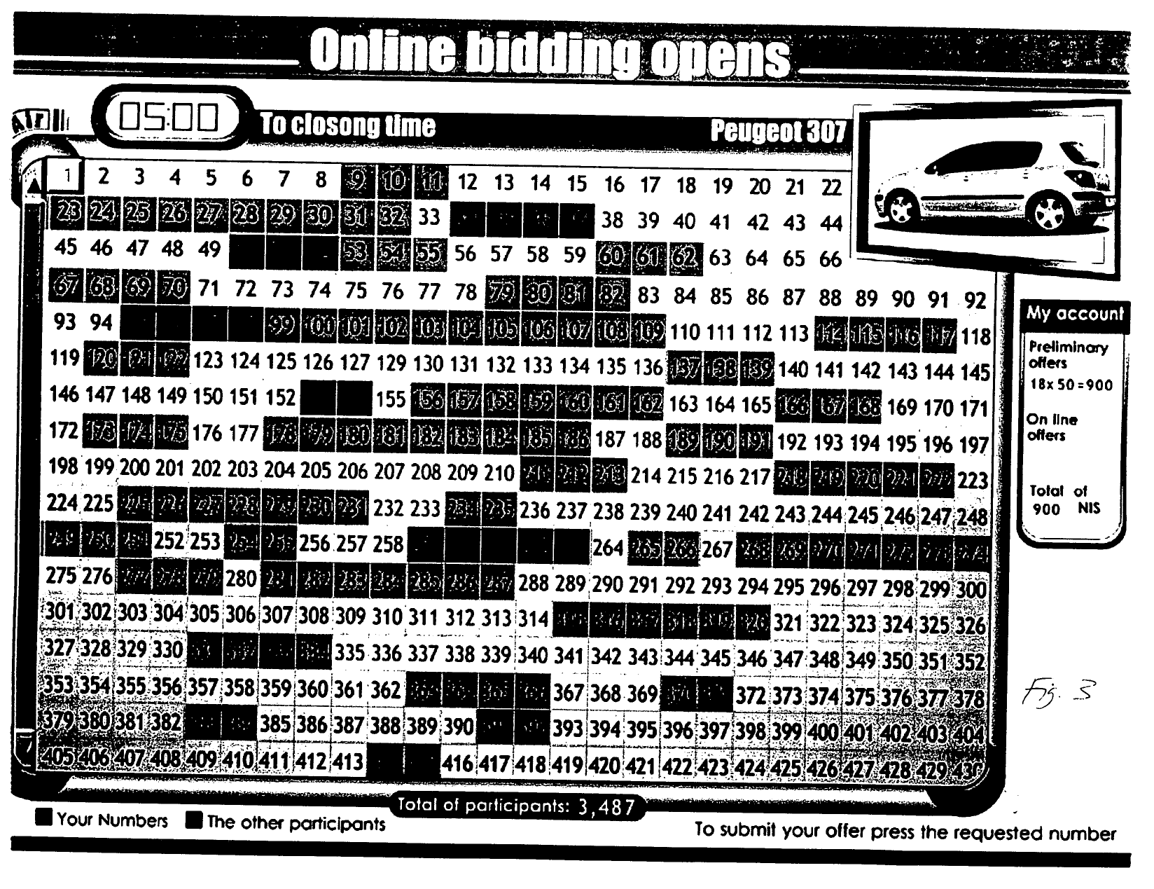

FIG. 4

During the auction, the user is shown a display of squares ranging from 1 to the maximum price of the object (which is 10% of its original price). The squares that were bought by the user before and during the auction are marked with a certain color (for example- red) and the squares bought by other users before and during the auction are marked with a different color (for example-gray). The user is shown the time left after which the auction will end (for example-The auction will end in 5 minutes). The marker is placed on the temporary winner (The winner for this second. It does not mean this square will be the winning one, for there is still time left.)

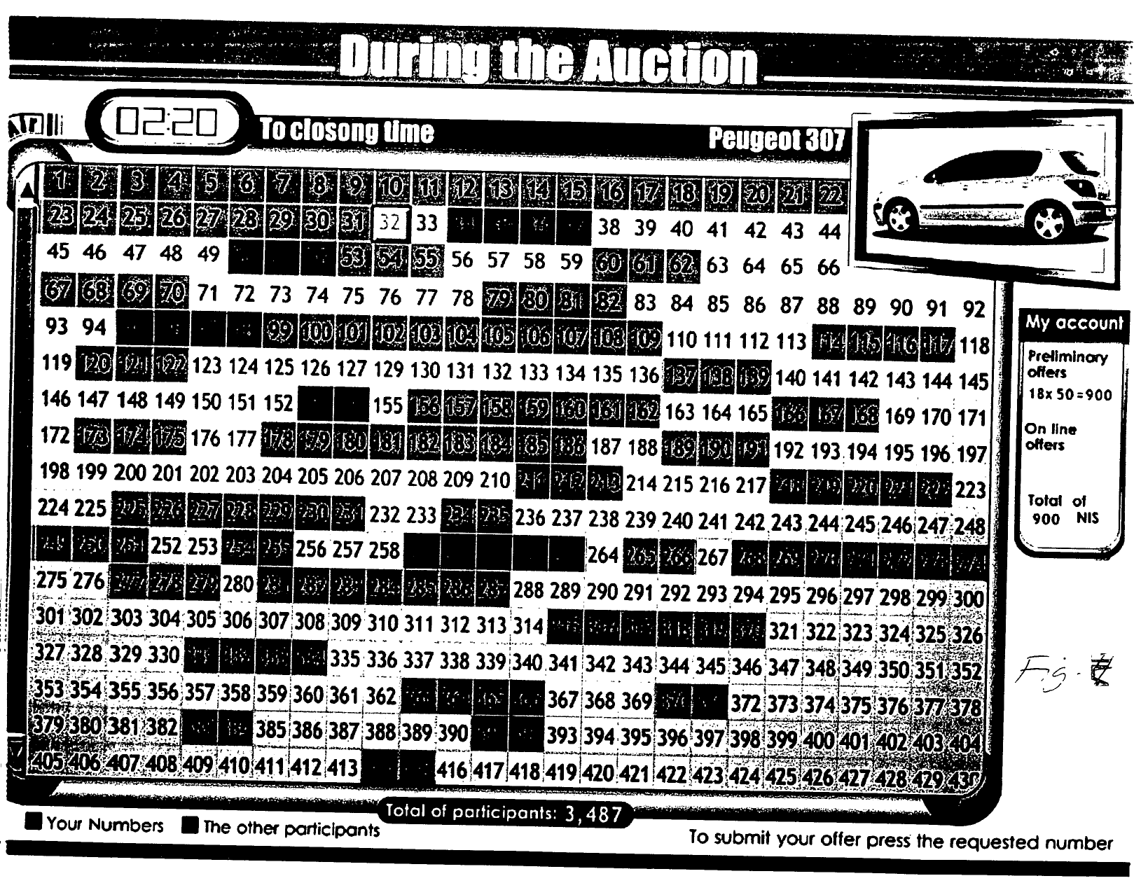

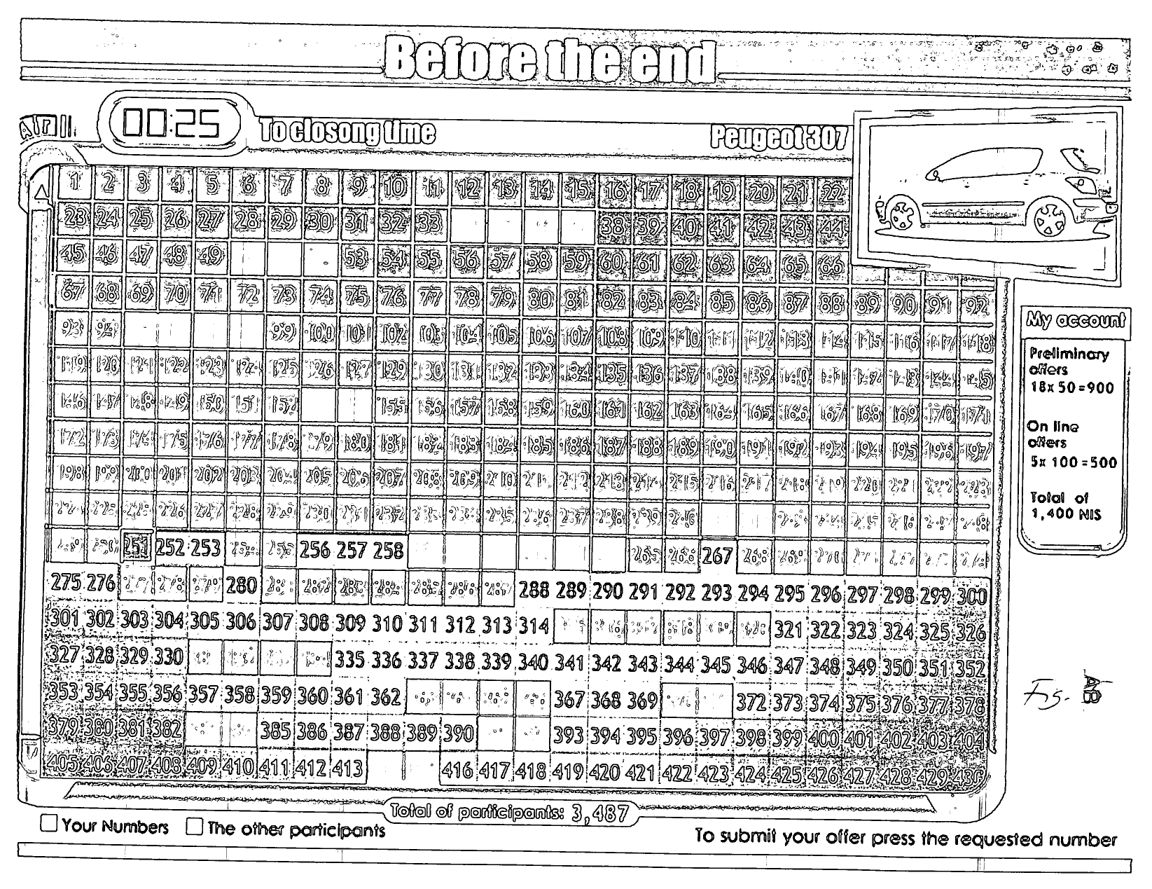

FIG. 5

Before closure of the game, the user is shown a display of squares ranging from 1 to the maximum price of the object (which is 10% of its original price). The squares that were bought by the user before and during the auction are marked with a certain color (for example-gray) and the squares bought by other users before and during the auction are marked with a different color (for example-red). The user is shown the time left after which the auction will end (for example-The auction will end in 25 seconds). The marker is placed for the temporary winner (The winner for this second. It does not mean this square will be the winning one, for there is still time left.)

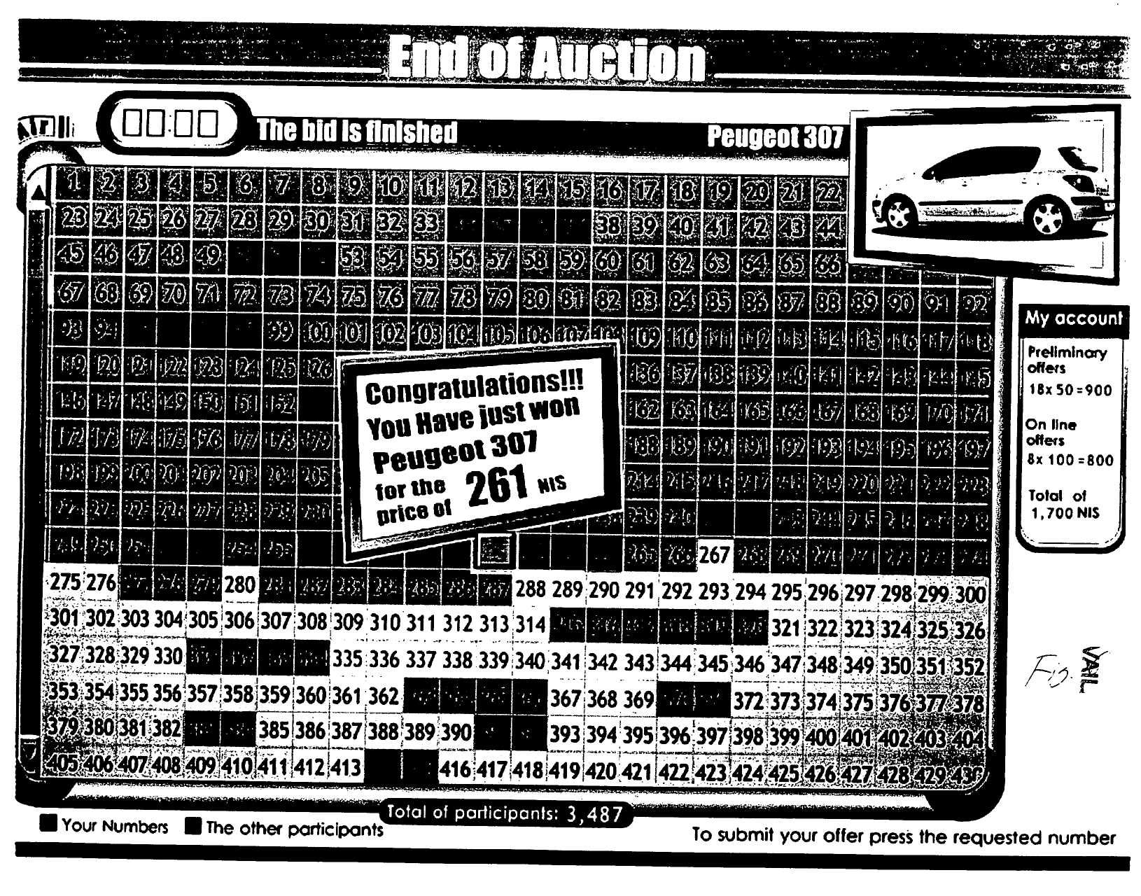

FIG. 6

The auction is closed. The user is shown a display of squares ranging from 1 to the maximum price of the object (which is 10% of its original price). The squares that were bought by the user before and during the auction are marked with a certain color (for example-gray) and the squares bought by other users before and during the auction are marked with a different color (for example-red). The user is shown that there is no time left. The square marked by the cursor is the winning one.

What is claimed is:

1. A method for an online auction game for a product for a plurality of users, comprising:
providing a display for displaying the game to each user;
placing a bid in a bidding process by a user;
altering said display to show progress in said bidding process to each user; and
constraining the bidding process to a predetermined period of time, such that said bid by said user is alterable during said predetermined period of time.

2. The method of claim 1, wherein said display shows a plurality of markers, and wherein said placing said bid comprises purchasing a marker by said user.

3. The method of claim 2, wherein said bidding process comprises:
displaying bids by the plurality of users; and
moving a selection marker on said display to a marker for a bid according to a plurality of criteria, said criteria including price of said bid;
wherein said user is capable of placing a plurality of bids and wherein a winner of the auction game is determined according to a location of said selection marker.
